(19) United States
(12) Patent Application Publication
(10) Pub. No.: US 2009/0147009 A1
(43) Pub. Date: Jun. 11, 2009

(54) VIDEO CREATING DEVICE AND VIDEO CREATING METHOD

(75) Inventors: Toshiyuki Tanaka, Kanagawa (JP); Sachiko Uranaka, Tokyo (JP); Makoto Yasugi, Kanagawa (JP); Seiya Miyazaki, Tokyo (JP); Koichi Emura, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/067,502

(22) PCT Filed: Sep. 20, 2006
(86) PCT No.: PCT/JP2006/318628

§ 371 Date: Mar. 20, 2008

(30) Foreign Application Priority Data
Sep. 21, 2005 (JP) 2005-274285

(51) Int. Cl. G06T 13/00

(52) U.S. Cl. 345/473

(57) ABSTRACT

A video creating device for creating a video full of originality from a text. A video viewer (102) has a user information list storage section (114), a user information adding section (119), a transmitting/receiving section (111), an animation constitutional element determining section (112), and an animation creating section (116). The user information list storage section (114) stores a user information list in which a set of a keyword for describing a story and a semantic content of the keyword is associated with an animation element used for creating an animation. The user information adding section (119) adds the association of the set of the keyword and the semantic content and the animation element to the user information list in response to the user information list in response to a user operation. The transmitting/receiving section (111) receives a character string with the semantic content including the keyword and the semantic content from a video producing device (101). The animation constitutional element determining section (112) determines an animation element corresponding to the set of the keyword included in the character string and the semantic content from the user information list. The animation creating section (116) creates an animation by using the determined animation element.

### TECHNICAL FIELD

The present invention relates to a video creating apparatus and video creating method that create animation video using an animation element based on a text that describes a story.

### BACKGROUND ART

Previously, a method has been proposed whereby a keyword constituting a story base is extracted, an animation element relating to the selected keyword is selected, and animation is created by combining these (see Patent Document 1, for example).

With this method, an animation element relating to an extracted keyword is selected from data provided in the system beforehand, and one animation data item is created.

### Patent Document 1: Unexamined Japanese Patent Publication No. 2002-366964

### DISCLOSURE OF INVENTION

### Problems to be Solved by the Invention

However, with the conventional method, a creator (producer) creates and stores an animation element relating to a keyword. Therefore, when a viewer creates video comprising animation data by inputting a keyword, the same animation element as intended by the creator is used regardless of the preference or wishes of the viewer. Thus, the same video is created by any viewer. That is to say, video seen by the video creator reaches the viewer as-is. Video created in this way reflects the intent of the creator but not the intent of the viewer.

It is an object of the present invention to provide a video creating method and video creating apparatus that enable video full of originality to be created easily from a text.

### Means for Solving the Problems

An aspect of the present invention is a video creating apparatus that creates animation using an animation element based on a story and employs a configuration that includes: an input section that inputs a character string with semantic content including a keyword for describing a story and semantic content assigned to that keyword; a user information list storage section that stores a user information list, which is a list in which a set of a keyword and semantic content for that keyword and an animation element used to create animation are associated on the side of a user playing back animation; an animation constituent element determining section that determines an animation element corresponding to a set of a keyword included in the input character string with semantic content and semantic content assigned to that keyword from the user information list; and an animation creating section that creates animation using the determined animation element.

Another aspect of the present invention is a video creating method that creates animation using an animation element based on a story and includes: a step of inputting a character string with semantic content including a keyword for describing a story and semantic content assigned to that keyword; a step of determining an animation element corresponding to a set of a keyword included in the input character string with semantic content and semantic content assigned to that keyword from a user information list, which is a list in which a set of a keyword and semantic content for that keyword and an animation element used to create animation are associated on the side of a user playing back animation; and a step of creating animation using the determined animation element.

### ADVANTAGEOUS EFFECT OF THE INVENTION

The present invention enables video full of originality and reflecting the intent of a viewer to be created without modifying a story indicated by a character string with semantic content.

### BRIEF DESCRIPTION OF DRAWINGS

FIG. 1 is a configuration diagram of an animation creating system according to one embodiment of the present invention;

FIG. 2 is a drawing showing a sample description of a keyword list according to this embodiment;

FIG. 3 is a drawing showing a sample description of a semantic content list according to this embodiment;

FIG. 4 is a drawing showing a sample description of a character string with semantic content according to this embodiment;

FIG. 5 is a drawing showing a sample description of an animation element information list according to this embodiment;

FIG. 6 is a first drawing showing a sample description of a user information list according to this embodiment;

FIG. 7 is a second drawing showing a sample description of a user information list according to this embodiment;

FIG. 8 is a drawing for explaining the operation of an animation constituent element determining section according to this embodiment;

FIG. 9 is a flowchart of processing by a keyword extracting section according to this embodiment;

FIG. 10 is a flowchart of processing by a user information adding section according to this embodiment;

FIG. 11 is a drawing for explaining processing by a user information adding section according to this embodiment;

FIG. 12 is a flowchart of processing by an animation constituent element determining section according to this embodiment;

FIG. 13 is a first drawing for explaining processing by an animation creating system according to this embodiment;

FIG. 14 is a second drawing for explaining processing by an animation creating system according to this embodiment;

FIG. 15 is a third drawing for explaining processing by an animation creating system according to this embodiment; and

FIG. 16 is a fourth drawing for explaining processing by an animation creating system according to this embodiment.

### BEST MODE FOR CARRYING OUT THE INVENTION

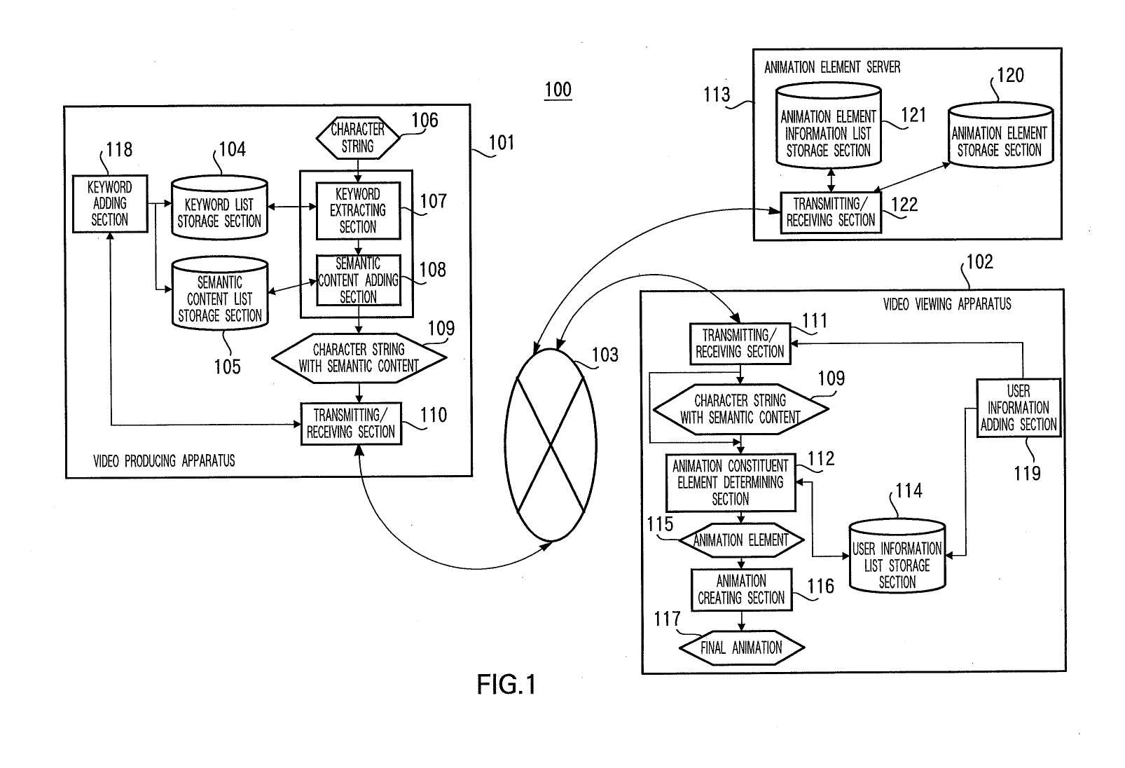

An embodiment of the present invention will now be described in detail with reference to the accompanying drawings. First, an animation creating system according to this embodiment of the present invention will be described using FIG. 1. FIG. 1 is a configuration diagram of an animation creating system according to this embodiment.

An animation creating system 100 according to this embodiment employs a mode in which a video producing apparatus 101, video viewing apparatus 102, and animation element server 113 are connected via a network 103. Video producing apparatus 101 and video viewing apparatus 102 may be incorporated in the same kind of apparatus. That is to say, a plurality of apparatuses equipped with both video producing apparatus 101 and video viewing apparatus 102 may be connected via network 103 or a public switched telephone network such as a mobile phone network.

First, the configuration of video producing apparatus 101 will be described. Video producing apparatus 101 has a keyword list storage section 104, a semantic content list storage section 105, a keyword extracting section 107, a semantic content adding section 108, a transmitting/receiving section 110, and a keyword adding section 118. A character string 106 comprising text that describes a story using a keyword is input to video producing apparatus 101.

Keyword list storage section 104 stores a list of keywords used to describe a story (hereinafter referred to as a ‘keyword list’).

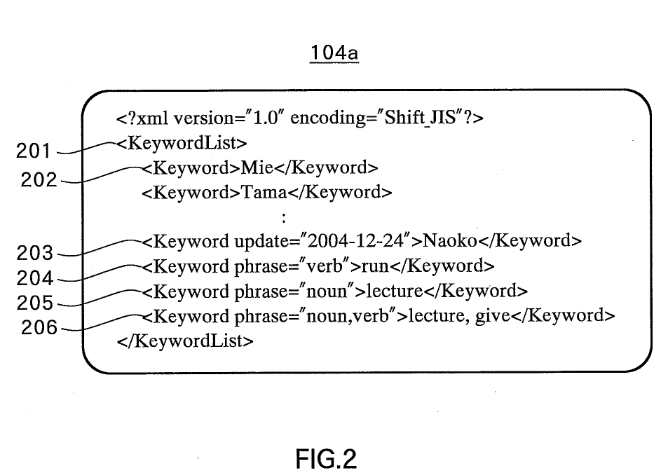

FIG. 2 shows a sample description of a keyword list. A keyword list 104a is written using XML (extensible markup language) as shown in FIG. 2.

The data contained in keyword list 104a will now be described in detail. ‘KeywordList’ 201 contains a plurality of ‘Keywords’ 202 through 206. In ‘Keyword’ 202 a keyword constituting an agent is written. In ‘Keyword’ 203 the date on which keyword ‘Naoko’ was added to keyword list 104a is described by an attribute ‘update’. In this way, information other than a keyword is also written.

In ‘KeywordList’ 201 are written ‘Keyword’ 204 indicating an action (verb), ‘Keyword’ 205 indicating a noun, and ‘Keyword’ 206 composed of a set of a noun and an action. Keyword list 104a is configured in this way. As described in detail later herein, keyword list 104a is used to extract a keyword from an input character string 106.

Semantic content list storage section 105 stores a semantic content list containing semantic content for keywords included in keyword list 104a.

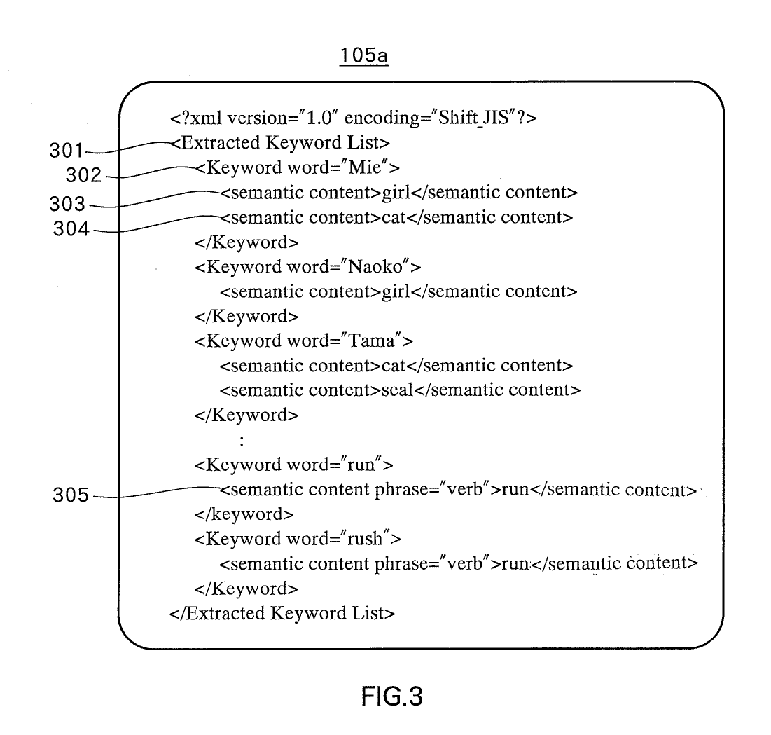

FIG. 3 shows a sample description of a semantic content list. A semantic content list 105a is written in XML as shown in FIG. 3. Semantic content list 105a will now be described in detail.

‘Extracted Keyword List’ 301 is written in semantic content list 105a. ‘Extracted Keyword List’ 301 is composed of a plurality of ‘Keywords’ 302 having one or more ‘semantic content’ items (303, 304) as sub-elements.

For example, a keyword ‘Mie’ is written for ‘Keyword’ 302 with an attribute ‘word’, and semantic content ‘girl’ is written for ‘semantic content’ 303 that is a ‘Keyword’ 302 sub-element character string. Similarly, semantic content ‘cat’ is written for ‘semantic content’ 304. That is to say, in ‘Keyword’ 302, the semantic content items ‘girl’ and ‘cat’ are defined for keyword ‘Mie’ Also, for ‘semantic content’ 305, the part of speech of the semantic content is described by the attribute ‘phrase’. Uniquely determined identification information may also be written for ‘semantic content’, such as a URI (uniform resource identifier) ‘http://abcde.co.jp/GIRL/’ for example.

Semantic content list 105a is configured as described above. As described in detail later herein, semantic content list 105a is used to add to a keyword extracted from a character string, semantic content of that keyword.

Thus, in animation creating system 100 shown in FIG. 1, keyword list 104a for extracting a keyword, and semantic content list 105a for adding semantic content to a keyword, are managed separately. By this means, it is possible for keyword list 104a to be shared by a plurality of persons by having keyword list 104a accessed from network 103 or uploaded to a Web server or the like, while semantic content list 105a to be managed personally. In this way, a user can be saved the trouble of individually setting a keyword for extraction.

Keyword extracting section 107 shown in FIG. 1 has character string 106 as input, and extracts a keyword contained in input character string 106 using keyword list 104a. Then keyword extracting section 107 outputs the extracted keyword to semantic content adding section 108. Keyword extraction processing by keyword extracting section 107 will be described in detail later herein using another drawing.

Semantic content adding section 108 extracts semantic content of the input keyword using semantic content list 105a, adds the extracted semantic content to the input keyword, and outputs a character string with semantic content 109 to transmitting/receiving section 110. If a plurality of semantic content items are written for one keyword, one of the semantic content items can be selected and extracted by, for example, displaying the options and asking the user to make a choice. Also, when the transmission destination of character string with semantic content 109 has been decided, appropriate semantic content may be selected and extracted based on an address book setting or ambient information such as the time, the creator's location, or the like.

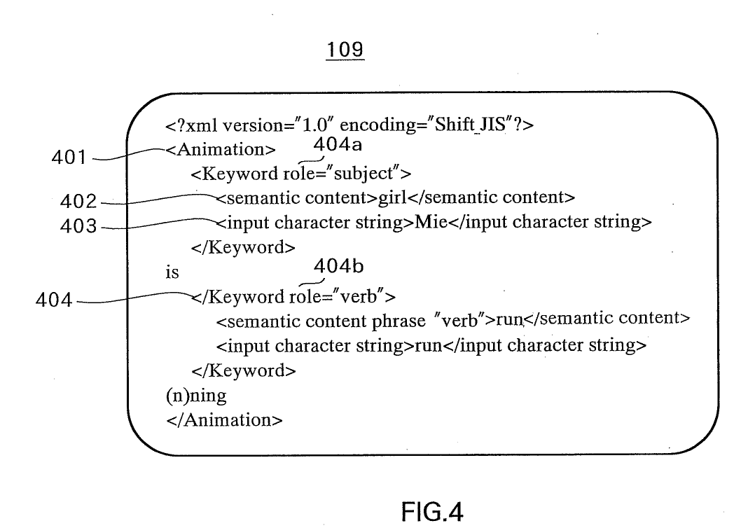

FIG. 4 shows a sample description of a character string with semantic content. Character string with semantic content 109 contains ‘Animation’ 401 showing each scene of an animation story. ‘Animation’ 401 includes an ‘input character string’ 403 that is a keyword extracted from character string 106, and ‘semantic content’ 402 added as semantic content thereof. Also, in character string with semantic content 109, input character string roles are described by ‘role’ attributes 404a and 404b. ‘Role’ attributes 404a and 404b enable the accuracy of animation constituent element selection processing by animation constituent element determining section 112 to be improved.

Character string with semantic content 109 is configured in this way. By creating character string with semantic content 109 from character string 106, information lacking in character string 106 can be supplied, enabling the expressiveness of created animation video to be improved. Also, since character string with semantic content 109 simply has semantic content added to a keyword in character string 106, the content of original character string 106 is not changed. That is to say, the relationship between original character string 106 and character string with semantic content 109 can be made one of reversibility. This makes it possible, for example, for original character string 106 to be reconstituted and displayed on the character string with semantic content 109 receiving side.

Here, a case is shown in which base character string 106 contains a keyword ‘Mie’ and a keyword ‘run’, ‘girl’ is selected as the semantic content of keyword ‘Mie’, and ‘run’ is selected as the semantic content of keyword ‘run’.

Transmitting/receiving section 110 shown in FIG. 1 sends character string with semantic content 109 to video viewing apparatus 102 via network 103. On the arrival of the semantic content and keywords from video viewing apparatus 102, transmitting/receiving section 110 receives them and sends them to keyword adding section 118.

Keyword adding section 118 adds the keywords and semantic content to keyword list 104a stored in keyword list storage section 104 and semantic content list 105a stored in semantic content list storage section 105. Keyword adding section 118 adds a keyword and semantic content input from another apparatus connected to network 103 via transmitting/receiving section 110, and a keyword and semantic content input by the user, and so forth, to keyword list 104a and semantic content list 105a. Specifically, when a keyword and semantic content of that keyword are input, keyword adding section 118 adds the keyword to keyword list 104a and also adds a set of the keyword and semantic content to semantic content list 105a. Alternatively, when a keyword already contained in keyword list 104a and semantic content list 105a is specified and semantic content is input, semantic content is added in the form of addition to the relevant keyword of semantic content list 105a. By this means, new content can be added to an initially defined keyword and semantic content, enabling an initially defined keyword and semantic content to be used over and over. It is also possible for keyword list 104a and semantic content list 105a to be edited not only by the user of video producing apparatus 101 but also by another user, such as the user of video viewing apparatus 102.

Video producing apparatus 101 is configured as described above. All keywords written in keyword list 104a may also be written in semantic content list 105a. Specifically, for example, video producing apparatus 101 may be provided with an apparatus section that searches keyword list 104a for a keyword not contained in semantic content list 105a, displays the relevant keyword, and has the user input semantic content. By this means, semantic content of some kind can be added by semantic content adding section 108 to all keywords extracted by keyword extracting section 107.

Next, the configuration of animation element server 113 will be described.

Animation element server 113 has an animation element storage section 120, an animation element information list storage section 121, and a transmitting/receiving section 122. Animation element storage section 120 stores various kinds of animation elements. Animation element information list storage section 121 stores an animation element information list, which is a list of animation elements stored in animation element storage section 120. In response to a request, transmitting/receiving section 122 transmits an animation element or animation element information list stored in animation element server 113 to video viewing apparatus 102 via network 103.

An animation element is raw data for creating animation video, and includes human, animal or suchlike character data, background data such as 3D space data, still images, or the like, property data such as a desk, ball, or the like, photo or movie data, motion data indicating the nature of an action by a character or the like, emotion/expression data for representing a character's expression, date data such as a birthday or anniversary, and so forth.

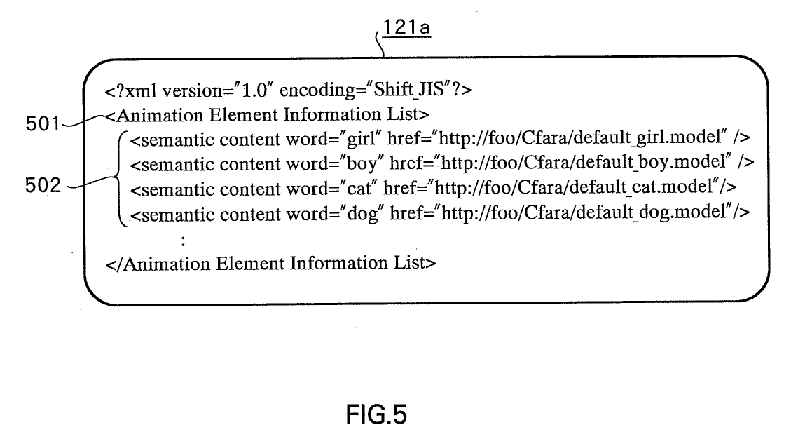

FIG. 5 shows a sample description of an animation element information list. As shown in FIG. 5, an animation element information list 121a includes an ‘Animation Element Information List’ 501 composed of a plurality of ‘semantic content’ items 502. For example, ‘semantic content’ items 502 include semantic content items ‘girl’, ‘boy’, ‘cat’, and ‘dog’ as attribute ‘word’, and an ID (reference destination) enabling an animation element to be identified as attribute ‘href’.

In FIG. 5, a mode is shown in which the reference destination of an animation element corresponding to semantic content is written, but the reference destination of an animation element corresponding to a set of semantic content and a keyword may also be written.

Thus, animation element server 113 contains preset semantic content and corresponding animation element reference destinations.

Animation element server 113 is configured as described above.

Next, video viewing apparatus 102 will be described. Video viewing apparatus 102 has a transmitting/receiving section 111, an animation constituent element determining section 112, a user information list storage section 114, an animation creating section 116, a user information adding section 119, and an animation element storage section (not shown) that stores various kinds of animation elements.

Transmitting/receiving section 111 receives a character string with semantic content 109 sent from video producing apparatus 101, and sends the received character string with semantic content 109 to animation constituent element determining section 112. Transmitting/receiving section 111 also receives an animation element information list 121a from animation element server 113 and sends it to animation constituent element determining section 112.

User information list storage section 114 stores a user information list, which is a list of animation elements for semantic content and keywords personally input and edited by a user on the animation playback and viewing side via user information adding section 119. The animation elements listed here may be animation elements stored in the animation element storage section of the apparatus, or may be animation elements stored in animation element storage section 120 of animation element server 113. As information relating to a utilizing user, user information may include the terminal performance, date and time, communication situation, user age, sex, interest information, and device usage history, a user-managed address book, and suchlike individual system related information.

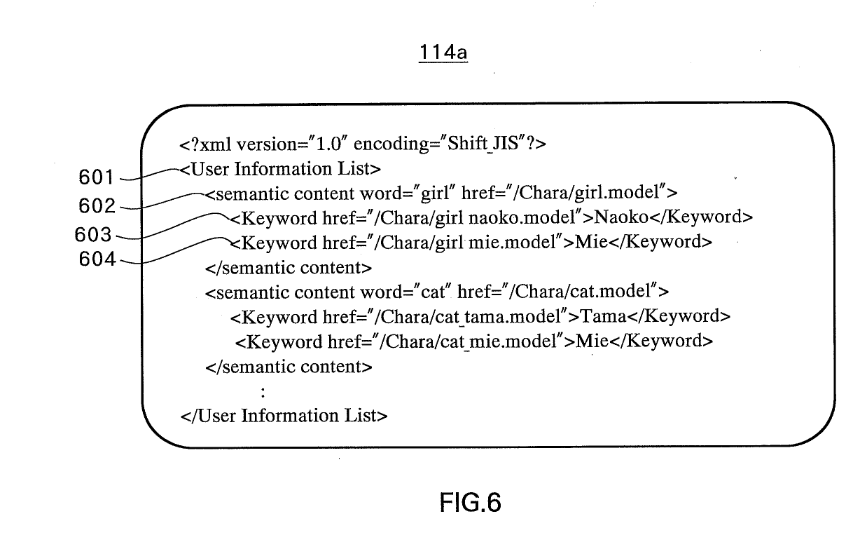

FIG. 6 is a drawing showing a sample description of a user information list according to this embodiment. As shown in FIG. 6, ‘User Information List’ 601 is written in a user information list 114a. ‘User Information List’ 601 is composed of a plurality of ‘semantic content’ items 602 having one or more ‘Keywords’ (603, 604) as sub-elements.

For example, semantic content ‘girl’ is written for ‘semantic content’ 602 with an attribute ‘word’, and a keyword ‘Naoko’ is written for ‘Keyword’ 603 as a sub-element character string. Similarly, a keyword ‘Mie’ is written for ‘Keyword’ 604. Also, for ‘semantic content’ 602 and ‘Keyword’ 603, an ID enabling an animation element to be identified is written as attribute ‘href’.

Thus, user information list 114a is a list of animation elements corresponding to keywords and semantic content registered by the user. User information list 114a may also be a list of animation elements for motion data.

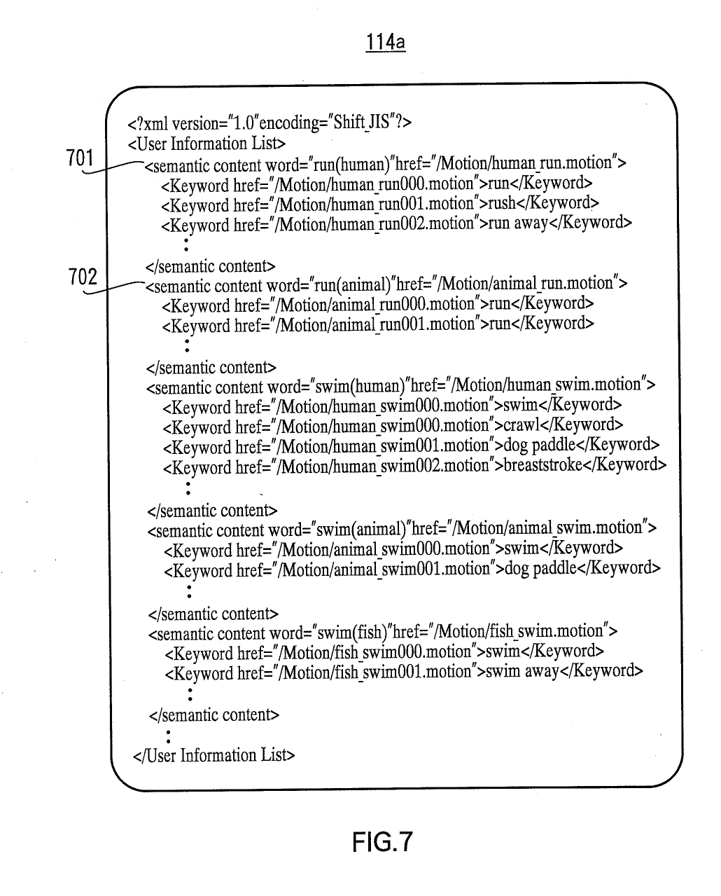

FIG. 7 is a drawing showing a sample description when user information list 114a is a list of animation elements for motion data. In this case, as shown by reference numbers 701 and 702 in the drawing, in user information list 114a reference destinations of animation elements for which the motion skeletal model should be ‘human’ and reference destinations of animation elements for which the motion skeletal model should be ‘animal’ are written for semantic content ‘run’. Providing associations with different animation elements according to the action object for the same semantic content action in this way makes it possible to select a more exact animation element.

Animation constituent element determining section 112 shown in FIG. 1 determines an animation element 115 for use in finally created animation (hereinafter referred to as ‘final animation’) from character string with semantic content 109 using animation element information list 121a and user information list 114a stored in user information list storage section 114, and sends this to animation creating section 116.

Animation creating section 116 creates final animation 117 from animation element 115 determined by animation constituent element determining section 112.

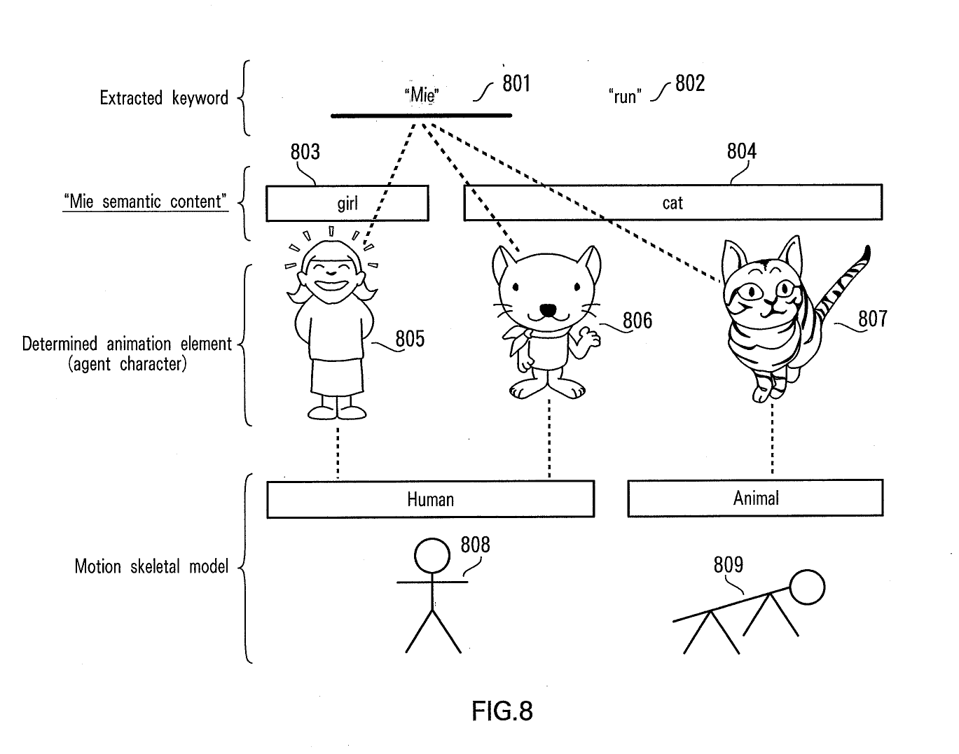

FIG. 8 is a drawing for explaining the operation of animation constituent element determining section 112. As shown in FIG. 8, a case is here described in which there are two character string with semantic content 109 keywords: ‘Mie’ 801 and ‘run’ 802.

As shown in FIG. 3, the semantic content of keyword ‘Mie’ 801 may be ‘girl’ 803 or ‘cat’ 804. Here, it is assumed that ‘girl’ 803 has been selected as the semantic content of keyword ‘Mie’ 801 by video producing apparatus 101. That is to say, it is assumed that character string with semantic content 109 with the content shown in FIG. 4 has been input.

In this case, animation constituent element determining section 112 searches for an animation element 805 corresponding to keyword ‘Mie’ and semantic content ‘girl’ in user information list 114a shown in FIG. 6, and determines this to be an agent character.

At this time, animation constituent element determining section 112 can determine an animation element from character string with semantic content 109 not only by means of a set of two kinds of information comprising ‘semantic content’ 602 and ‘Keywords’ 603 and 604, but also by means of ‘semantic content’ 602 alone.

On the other hand, a case in which ‘cat’ 804 has been selected by video producing apparatus 101 as the semantic content of ‘Mie’ 801 will be considered. In this case, animation constituent element determining section 112 searches for animation elements 806 and 807 corresponding to keyword ‘Mie’ and semantic content ‘cat’ in user information list 114a, and determines one or the other to be an agent character.

Next, animation constituent element determining section 112 proceeds to determination processing for an animation element of the other keyword ‘run’ 802 (in this case, motion data). At this time, animation constituent element determining section 112 uses animation element 805 information as to which skeletal model—‘human’ or ‘animal’—the animation element determined to be an agent character corresponds. By this means, the selected skeletal model can be narrowed down to human 808 motion.

For example, the skeletal model of the model constituting an agent differs for animation elements 806 and 807 shown in FIG. 8. By using information on these determined animation elements (in this case, agent characters), as the skeletal model of motion data that is an animation element of keyword ‘run’ 802, motion of the same human model 808 as in the case of animation element 805 is selected in the case of animation element 806, and motion of a four-legged animal model 809 is selected in the case of animation element 807.

By using semantic content and keywords in this way, animation constituent element determining section 112 can determine an animation element (motion data) more accurately even when a plurality of animation elements exist for the same keyword.

User information adding section 119 shown in FIG. 1 adds new keywords and semantic content to user information list 114a of user information list storage section 114 by means of a user operation. User information adding section 119 sends semantic content and keywords added by the user to video producing apparatus 101 via transmitting/receiving section 111, and also has them added to above-described keyword list 104a and semantic content list 105a of video producing apparatus 101. User information adding section 119 processing will be described in detail later herein using another drawing.

Video viewing apparatus 102 is configured as described above.

Although not shown in the drawing, video producing apparatus 101, video viewing apparatus 102, and animation element server 113 shown in FIG. 1 each have a CPU (central processing unit), a storage medium such as ROM (read only memory) that stores a control program, working memory such as RAM (random access memory), and communication circuitry. That is to say, the CPU of each apparatus implements the functions of each section described above by executing a control program.

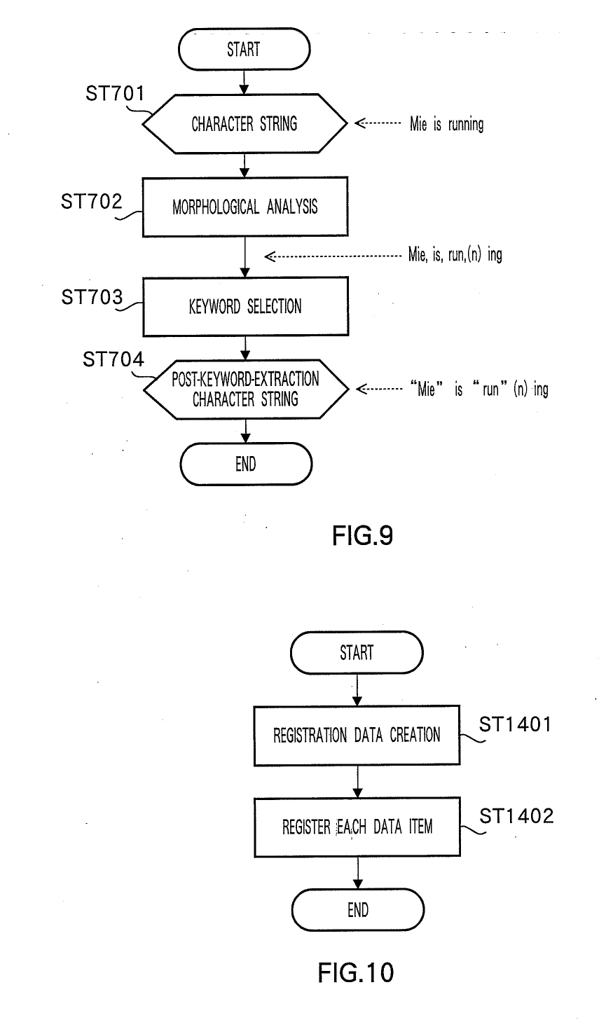

Next, keyword extraction processing by keyword extracting section 107 according to this embodiment will be described in detail using FIG. 9. FIG. 9 is a flowchart of processing by keyword extracting section 107 according to this embodiment.

First, keyword extracting section 107 has a character string 106 as input (ST701), and performs morphological analysis (ST702). Next, keyword extracting section 107 refers to keyword list 104a and performs keyword selection (ST703), and then generates a post-keyword-extraction character string by performing markup on the selected keyword (ST704).

For example, if character string 106 is ‘Mie is running’, keyword extracting section 107 extracts the four morphemes ‘Mie’, ‘is’, ‘run’, ‘(n)ing’ by morphological analysis, selects morphemes corresponding to keywords from the extracted morphemes, encloses the selected morphemes in double quotation marks, and outputs the post-keyword-extraction character string ‘“Mie” is “run” (n)ing’.

Here, the execution of morphological analysis by keyword extracting section 107 is in order to improve the accuracy of the extracted keywords. For example, if the input character string is ‘I give a lecture’, this is broken down into the four morphemes ‘I’, ‘give, ‘a’, ‘lecture’, but since ‘Keyword’ 206 ‘give a lecture’ is written in ‘KeywordList’ 201 in FIG. 2, this becomes not ‘I give a “lecture”’, but ‘I “give a lecture”’. Also, to improve the accuracy of keyword extraction here, linguistic fluctuation may be absorbed by using ontology or the like. The processing in ST702 that performs morphological analysis may be omitted for a language such as English in which word boundaries are clearly defined.

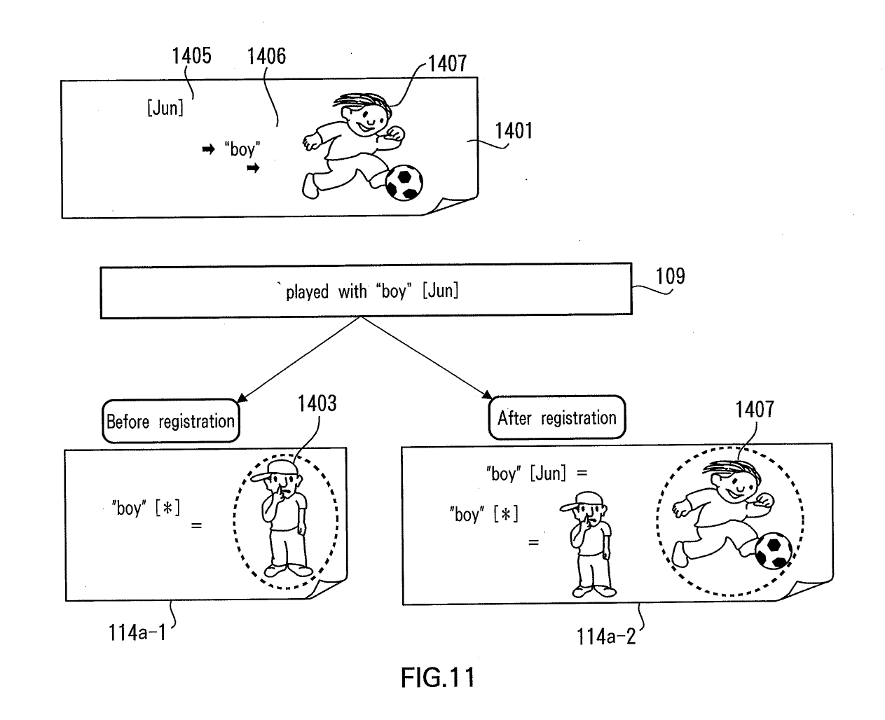

Next, processing by user information adding section 119 according to this embodiment will be described in detail using FIG. 10 and FIG. 11. FIG. 10 is a drawing showing a flowchart of processing by user information adding section 119, and FIG. 11 is a drawing for explaining that processing. In the following description and related drawings, a character string enclosed in square brackets represents a keyword, a character string enclosed in double quotation marks represents semantic content, and the symbol ‘*’ is a wild card whose content is not particularly relevant.

First, user information adding section 119 receives input of three data items—an animation element 1407 to be added, semantic content “boy” 1406, and extracted keyword [Jun] 1405—by means of a user operation, and creates a set of these three data items 1401 (ST1401). Next, among data 1401 created in ST1401, user information adding section 119 registers extracted keyword 1405 in keyword list 104a of video producing apparatus 101, and registers both extracted keyword 1405 and semantic content 1406 in semantic content list 105a of video producing apparatus 101 in a mutually associated state. Specifically, by being sent to video producing apparatus 101 via transmitting/receiving section 111, extracted keyword 1405 and semantic content 1406 are registered in keyword list 104a and semantic content list 105a respectively by keyword adding section 118 of video producing apparatus 101. User information adding section 119 also registers extracted keyword 1405, semantic content 1406, and animation element 1407 in user information list 114a in a mutually associated state (ST1402).

Animation element 1407 added by user information adding section 119 need not necessarily be actual data, but may be link information such as a URL (uniform resource locator). Also, extracted keyword 1405 may use the ‘*’ (wild card) symbol.

Here, it is assumed that only the association between ‘“boy” [*]’ and an animation element 1403 is described in initial-state user information list 114a-1. In this case, when, for example, character string with semantic content 109 ‘played with “boy” [Jun].’ is input, animation constituent element determining section 112 determines above-mentioned animation element 1403. However, if user information list 114a-2 after above-described data set 1401 has been registered is used, animation constituent element determining section 112 determines animation element 1407, not animation element 1403.

Thus, animation element 1403 has been determined by animation constituent element determining section 112 for all keywords whose semantic content is ‘boy’, but by registration of data set 1401, a different animation element 1407 will be determined for an item whose keyword is ‘Jun’. That is to say, the preference of the viewing user will be reflected.

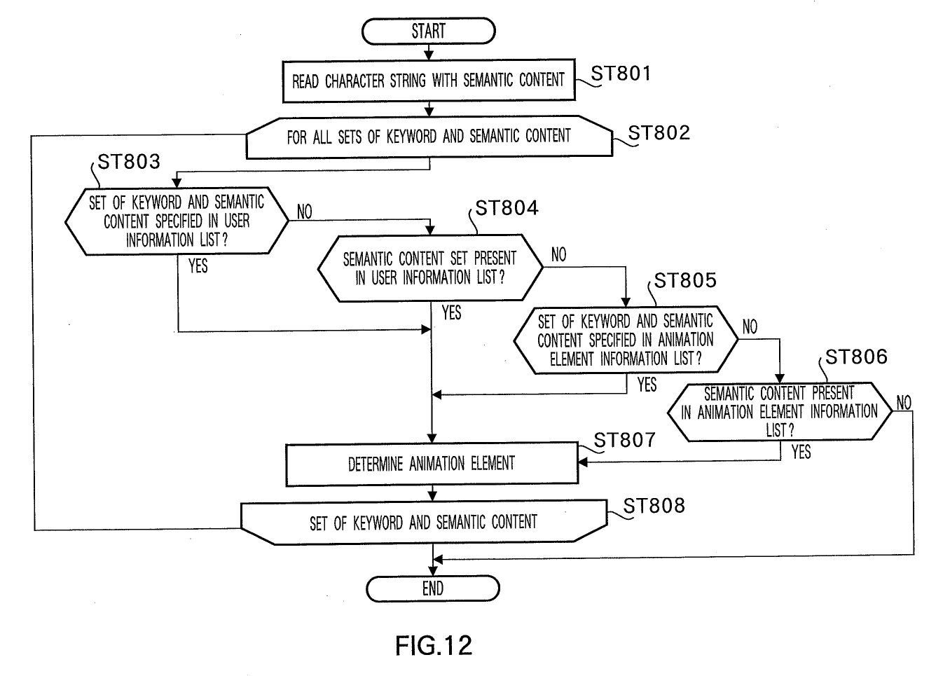

Next, processing by animation constituent element determining section 112 according to this embodiment will be described in detail using FIG. 12. FIG. 12 is a flowchart showing processing by animation constituent element determining section 112 according to this embodiment.

First, animation constituent element determining section 112 reads character string with semantic content 109 (ST801), and performs the following processing on all sets of keyword and semantic content (ST802, ST808).

First, animation constituent element determining section 112 refers to user information list 114a and determines whether a matching set of keyword and semantic content has been specified in user information list 114a. If a matching set of keyword and semantic content has been specified in user information list 114a (ST803: YES) animation constituent element determining section 112 determines an animation element corresponding to the relevant keyword and semantic content (ST807).

If a matching set of keyword and semantic content has not been specified in user information list 114a (ST803: NO), animation constituent element determining section 112 searches user information list 114a and determines whether or not matching semantic content is present. If matching semantic content is present in user information list 114a (ST804: YES), animation constituent element determining section 112 determines an animation element corresponding to the relevant semantic content (ST807).

Thus, if there is animation information corresponding to character string with semantic content 109 in user information list 114a, user information list 114a is selected and extracted with the highest priority.

If matching semantic content is not present in user information list 114a (ST804: NO), animation constituent element determining section 112 accesses animation element server 113 and searches animation element information list 121a, and determines whether or not a matching set of keyword and semantic content is present in animation element information list 121a (ST805). If a matching set of keyword and semantic content is present in animation element information list 121a (ST805: YES), animation constituent element determining section 112 determines an animation element corresponding to the relevant set of keyword and semantic content (ST807).

If a matching set of keyword and semantic content is not present in animation element information list 121a (ST805: NO), animation constituent element determining section 112 searches animation element information list 121a and determines whether or not matching semantic content is present (ST806). If matching semantic content is present in animation element information list 121a (ST806: YES), animation constituent element determining section 112 determines an animation element corresponding to the relevant semantic content (ST807).

If matching semantic content is not present in animation element information list 121a either (ST806: NO), animation constituent element determining section 112 terminates the series of processing steps.

Thus, when an animation element corresponding to character string with semantic content 109 is not present in user information list 114a, animation constituent element determining section 112 selects an animation element provided in advance by the system from animation element information list 121a.

Since the processing in ST803 and ST804 is processing using user information list 114a, and the processing in ST805 and ST806 is processing using animation element information list 121a, these two sets of processing may be performed simultaneously in parallel.

Registering an animation element determined in ST807 via processing in ST803 through ST806 in user information list 114a and using that information enables the accuracy of other animation element determination processing to be improved.

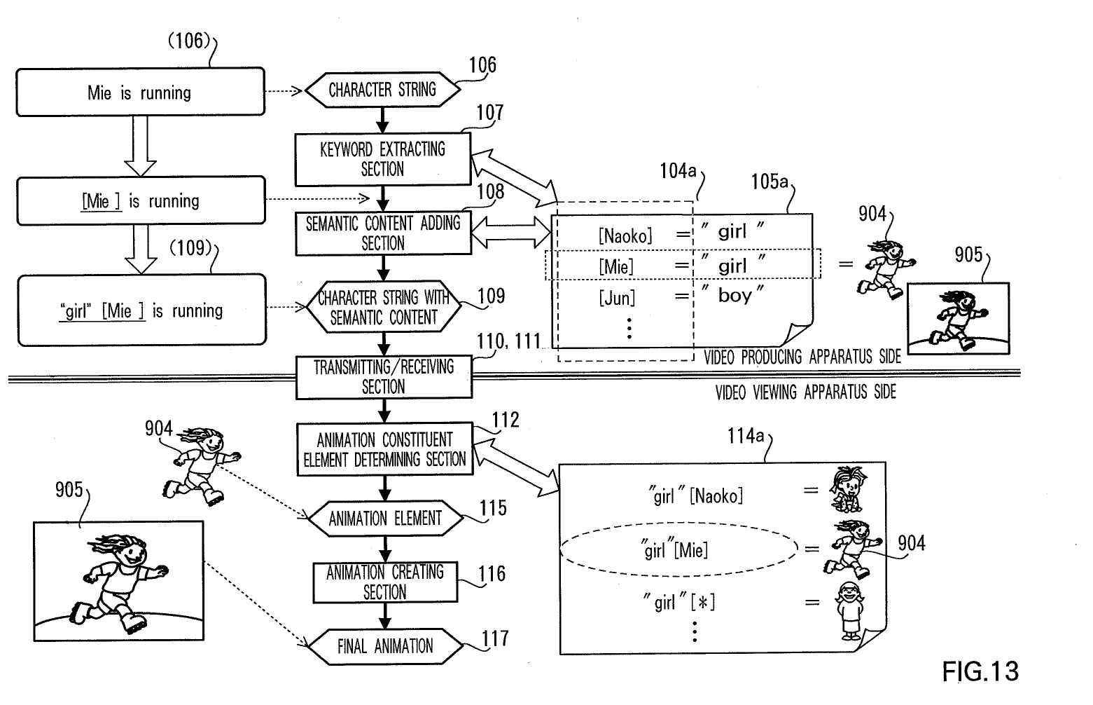

Actual examples of animation creating system 100 operation will now be described using FIG. 13 through FIG. 16. FIG. 13 through FIG. 16 show examples of animation creating system 100 operation with different user information list 114a contents.

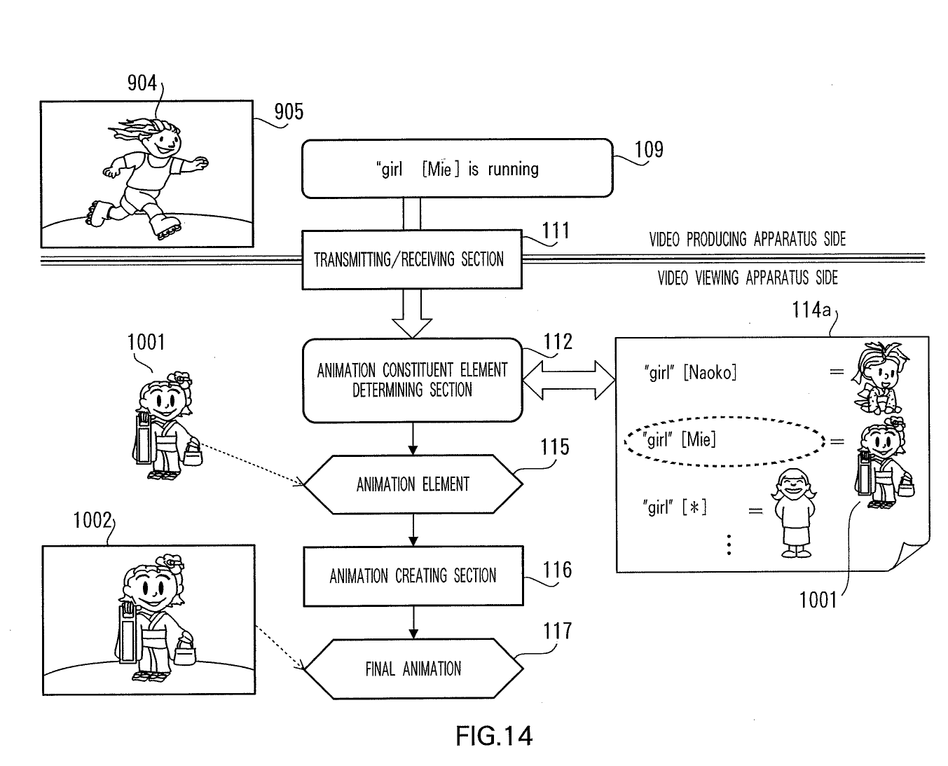

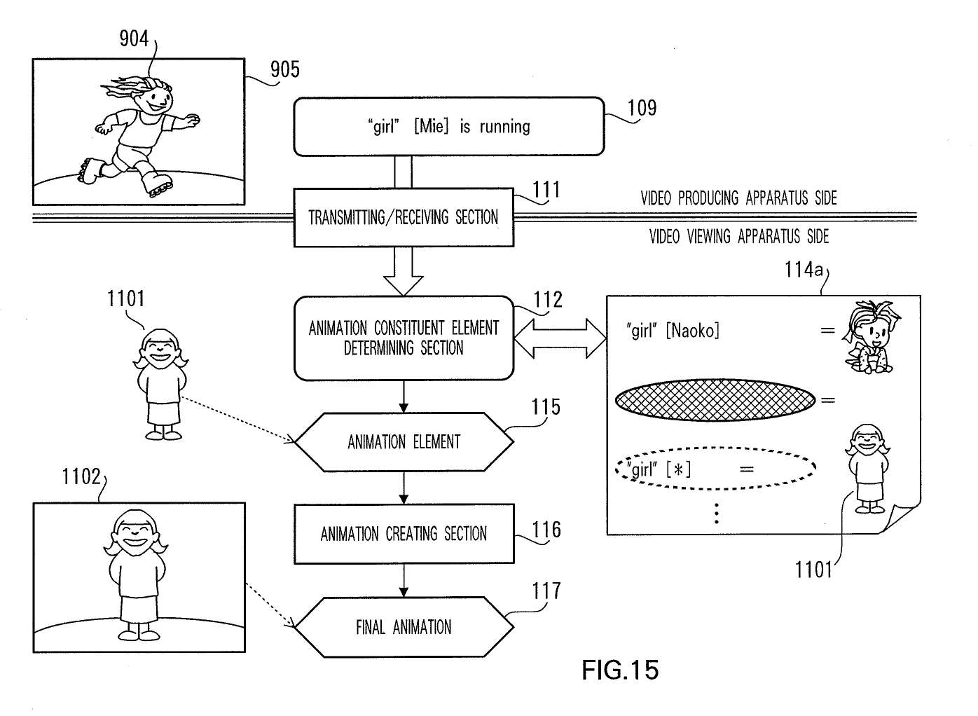

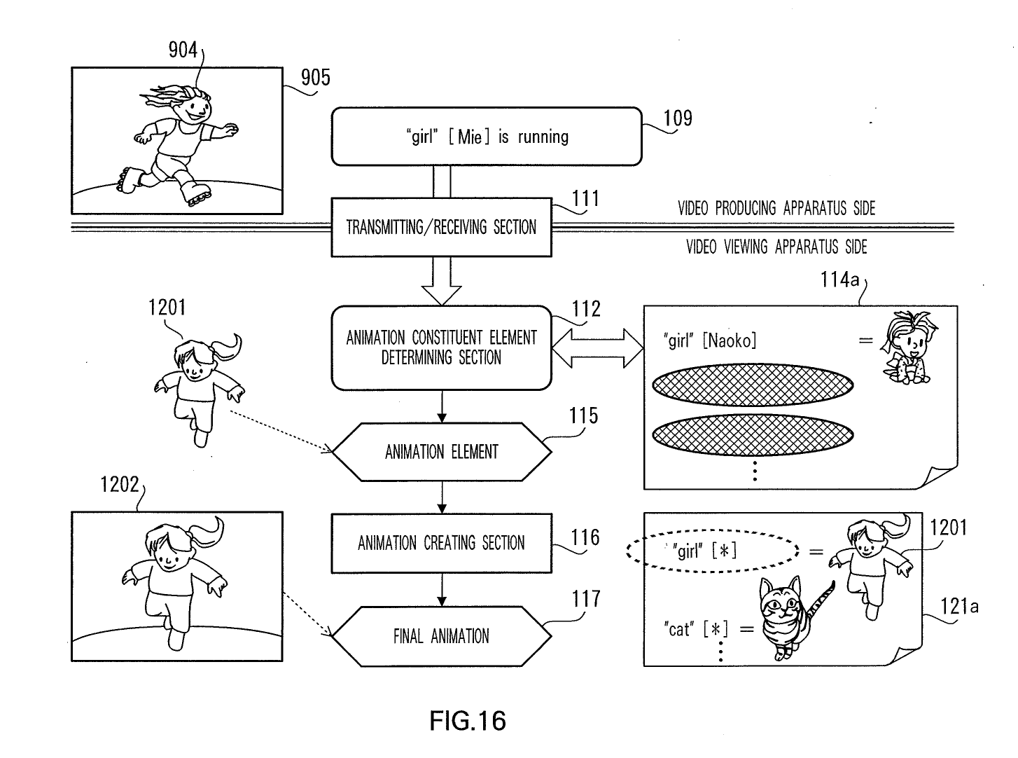

FIG. 13 shows a case in which a set comprising semantic content “girl” and keyword [Mie] is present in user information list 114a, and the same animation element as on the video producing apparatus 101 side is associated with that set. FIG. 14 shows a case in which a set comprising semantic content “girl” and keyword [Mie] is present in user information list 114a, and an animation element different from that on the video producing apparatus 101 side is associated with that set. FIG. 15 shows a case in which a set comprising semantic content “girl” and keyword [Mie] is not present in user information list 114a, but an animation element is associated with semantic content “girl” that is unrelated to keyword content. FIG. 16 shows a case in which a set comprising semantic content “girl” and keyword [Mie] is not present in user information list 114a, and semantic content “girl” that is unrelated to keyword content is not present either, but has been previously established in the system—that is, in animation element information list 121a.

Processing whereby video viewing apparatus 102 controls final animation 117 will now be described for each of the cases illustrated in FIG. 13 through FIG. 16. In all cases, it is assumed that video producing apparatus 101 has character string 106 ‘Mie is running’ as input. For the sake of simplicity, only the word ‘Mie’ will be considered in the following explanation.

In the case shown in FIG. 13, keyword extracting section 107 refers to keyword list 104a and extracts keyword ‘Mie’ from character string 106 ‘Mie is running’ Semantic content adding section 108 refers to semantic content list 105a and extracts semantic content “girl” corresponding to keyword ‘Mie’ Then semantic content adding section 108 creates character string with semantic content 109 ‘“girl” [Mie] is running’, and transmits this to video viewing apparatus 102 via transmitting/receiving section 110. It is here assumed that, on the video producing apparatus 101 side, a particular animation element 904 is associated with the set of semantic content and keyword ‘“girl” [Mie] is running’, and animation 905 using animation element 904 is intended to be generated. Transmitting/receiving section 111 of video viewing apparatus 102 receives character string with semantic content 109 ‘“girl” [Mie] is running’, and sends this to animation constituent element determining section 112.

Animation constituent element determining section 112 extracts the set of semantic content and keyword ‘“girl” [Mie]’ included in character string with semantic content 109 ‘“girl” [Mie] is running’. Then animation constituent element determining section 112 refers to user information list 114a and determines whether an animation element corresponding to set of semantic content and keyword ‘“girl” [Mie]’ is present. In user information list 114a shown in FIG. 14, animation element 904 is associated with set of semantic content and keyword ‘“girl” [Mie]’ in the same way as in video producing apparatus 101, and therefore animation constituent element determining section 112 determines animation element 904 as animation element 115 applying to keyword ‘Mie’, and sends this to animation creating section 116.

Then animation creating section 116 creates animation 905 using animation element 904, and outputs this as final animation 117. Animation creating section 116 may, for example, reconstitute original character string 106 from character string with semantic content 109 and perform voice readout or the like, creating animation with audio as video.

Thus, in the case shown in FIG. 13, animation element 115 is determined using user information list 114a, and final animation identical to animation 905 intended on the video producing apparatus 101 side and based on the user's preference is created.

In the case shown in FIG. 14, first, as in the case shown in FIG. 13, video producing apparatus 101 sends character string with semantic content 109 ‘“girl” [Mie] is running’ to video viewing apparatus 102. Transmitting/receiving section 111 of video viewing apparatus 102 receives character string with semantic content 109 ‘“girl” [Mie] is running’, and sends this to animation constituent element determining section 112.

Next, animation constituent element determining section 112 extracts the set of semantic content and keyword ‘“girl” [Mie]’ included in character string with semantic content 109 ‘“girl” [Mie] is running’. Then animation constituent element determining section 112 refers to user information list 114a and determines whether an animation element corresponding to set of semantic content and keyword ‘“girl” [Mie]’ is present. In user information list 114a shown in FIG. 14, an animation element 1001 different from animation element 904 is associated with set of semantic content and keyword ‘“girl” [Mie]’, and therefore animation constituent element determining section 112 determines animation element 1001 as animation element 115 applying to keyword ‘Mie’, and sends this to animation creating section 116.

Then animation creating section 116 generates animation 1002 using animation element 1001, and outputs this as final animation 117.

Thus, in the case shown in FIG. 14, animation element 115 is determined using user information list 114a with contents different from associations on the video producing apparatus 101 side, and therefore final animation 1002 differing from animation 905 intended on the video producing apparatus 101 side and based on the user's preference is created.

In the case shown in FIG. 15, first, as in the case shown in FIG. 13, video producing apparatus 101 sends character string with semantic content 109 ‘“girl” [Mie] is running’ to video viewing apparatus 102. Transmitting/receiving section 111 of video viewing apparatus 102 receives character string with semantic content 109 ‘“girl” [Mie] is running’, and sends this to animation constituent element determining section 112.

Next, animation constituent element determining section 112 extracts the set of semantic content and keyword ‘“girl” [Mie]’ included in character string with semantic content 109 ‘“girl” [Mie] is running’. Then animation constituent element determining section 112 refers to user information list 114a and determines whether an animation element corresponding to set of semantic content and keyword ‘“girl” [Mie]’ is present. In user information list 114a shown in FIG. 15, there is no animation element corresponding to set of semantic content and keyword ‘“girl” [Mie]’.

Therefore, animation constituent element determining section 112 next determines whether an animation element corresponding to semantic content “girl” is present in user information list 114a. As an animation element 1101 corresponding to semantic content “girl” is present in user information list 114a shown in FIG. 15, animation constituent element determining section 112 determines animation element 1101 as animation element 115 applying to keyword ‘Mie’, and sends this to animation creating section 116.

Then animation creating section 116 generates animation 1102 using animation element 1101, and outputs this as final animation 117.

Thus, in the case shown in FIG. 15, animation element 115 is determined using user information list 114a with contents different from associations on the video producing apparatus 101 side, and therefore final animation 1102 differing from animation 905 intended on the video producing apparatus 101 side and based on the user's preference is created.

In the case shown in FIG. 16, first, as in the case shown in FIG. 13, video producing apparatus 101 sends character string with semantic content 109 ‘“girl” [Mie] is running’ to video viewing apparatus 102. Transmitting/receiving section 111 of video viewing apparatus 102 receives character string with semantic content 109 ‘“girl” [Mie] is running’, and sends this to animation constituent element determining section 112.

Next, animation constituent element determining section 112 extracts the set of semantic content and keyword ‘“girl” [Mie]’ included in character string with semantic content 109 ‘“girl” [Mie] is running’. Then animation constituent element determining section 112 refers to user information list 114a and determines whether an animation element corresponding to set of semantic content and keyword ‘“girl” [Mie]’ is present. In user information list 114a shown in FIG. 16, there is no animation element corresponding to set of semantic content and keyword ‘“girl” [Mie]’.

Therefore, animation constituent element determining section 112 determines whether an animation element corresponding to semantic content “girl” is present in user information list 114a. An animation element corresponding to semantic content “girl” is not present in user information list 114a shown in FIG. 16.

Therefore, animation constituent element determining section 112 next determines whether an animation element corresponding to set of semantic content and keyword ‘“girl” [Mie]’ is present in animation element information list 121a of animation element server 113. However, there is no animation element corresponding to set of semantic content and keyword ‘“girl” [Mie]’ in animation element information list 121a shown in FIG. 16.

Therefore, animation constituent element determining section 112 next determines whether an animation element corresponding to semantic content “girl” is present in animation element information list 121a. As an animation element 1201 corresponding to semantic content “girl” is present in animation element information list 121a shown in FIG. 16, animation constituent element determining section 112 determines animation element 1201 as animation element 115 applying to keyword ‘Mie’, and sends this to animation creating section 116.

Then animation creating section 116 generates animation 1202 using animation element 1201, and outputs this as final animation 117.

Thus, in the case shown in FIG. 16, a corresponding animation element 115 is not present in user information list 114a, but final animation 1202 stipulated by the system is created by using animation element information list 121a stipulated by the system. Since animation element information list 121a with contents different from associations on the video producing apparatus 101 side is used, final animation 1202 differing from animation 905 intended on the video producing apparatus 101 side is created.

As described above, according to this embodiment, video can be created using an animation element based on information of a user of video viewing apparatus 102 without modifying a story (character string with semantic content) of video created by video producing apparatus 101. That is to say, video full of originality and reflecting the intent of a viewer can be created and viewed using an animation element conforming to the preference of a user of video viewing apparatus 102 without modifying a story intended on the video producing apparatus 101 side. In other words, intentions on the story creation side and intentions on the side on which a video is created using that story can be reconciled in a balanced manner. Also, since a character string with semantic content is created with the original character string 106 description content preserved, original character string 106 can be reconstituted on the video viewing apparatus 102 side. Furthermore, users can create their own unique videos by associating their individually created animation elements with animation elements.

In this embodiment, a mode has been described in which video producing apparatus 101, video viewing apparatus 102, and animation element server 113 are connected via network 103, but a mode may also be used in which video producing apparatus 101, video viewing apparatus 102, and animation element server 113 are provided in the same apparatus, and a mode may also be used in which video producing apparatus 101 and video viewing apparatus 102 are provided in the same apparatus. When such a mode is employed, the keyword adding section and user information adding section may extract a keyword and/or semantic content from a character string with semantic content sent from another apparatus, and perform information addition to a keyword list, semantic content list, or user information list held by their own apparatus.

A video creating apparatus according to a first aspect of the present invention employs a configuration that includes: a user information list, which is a list in which a set of a keyword and semantic content for that keyword and an animation element used to create animation are associated based on the preference of a user; a user information adding section that adds a set of a keyword and semantic content and an animation element corresponding to that set to the user information list based on the preference of a user; an animation constituent element determining section that inputs a character string with semantic content composed of a keyword and semantic content assigned to that keyword, and determines an animation element corresponding to the keyword and semantic content of the input character string with semantic content from the user information list; and an animation creating section that creates animation from the determined animation element.

By this means, video full of originality and reflecting the intent of a viewer can be created using an animation element based on user preference not provided in the system without modifying a story indicated by a character string with semantic content. That is to say, intentions on the story creation side and intentions on the side on which a video is created using that story can be reconciled in a balanced manner. Also, an animation element can be determined from a keyword to which semantic content is assigned. For example, if there is a keyword ‘Mie’ and that keyword has two semantic content items, ‘girl’ and ‘cat’, an appropriate animation element can be determined even though the keyword is the same by taking the semantic content as a clue. Also, since a character string with semantic content simply has semantic content added to a keyword for describing a story, the original content is not changed. That is to say, the relationship between description content according to an original keyword and a character string with semantic content can be made one of reversibility.

According to a second aspect of the present invention, in a video creating apparatus according to the first aspect, the animation constituent element determining section, when there is no animation element corresponding to an input keyword and semantic content in the user information list, determines an animation element corresponding to the input semantic content from the user information list.

By this means, even if an association of an animation element corresponding to a set of a keyword and semantic content assigned to that keyword is not present in the user information list, an appropriate animation element can be determined using the user information list based on semantic content.

According to a third aspect of the present invention, in a video creating apparatus according to the second aspect, the animation constituent element determining section, when there is no animation element corresponding to input semantic content in the user information list, determines an animation element corresponding to the input semantic content from a previously established animation element information list, which is a list in which a set of a keyword and semantic content assigned to that keyword and an animation element are associated.

By this means, even if the user information list cannot be used, video can be created using a previously established animation element.

According to a fourth aspect of the present invention, in a video creating apparatus according to the first aspect a user information adding section is provided that adds an association between a set of a keyword and semantic content for that keyword and an animation element to the user information list.

By this means, the user information list can be edited by individual users. It is also possible for edited information to be shared with other users.

A fifth aspect of the present invention is a video creating method that includes: a step of providing a user information list, which is a list in which a set of a keyword and semantic content for that keyword and an animation element used to create animation are associated based on the preference of a user; a step of, when a character string with semantic content composed of a keyword and semantic content assigned to that keyword is input, determining an animation element corresponding to the keyword and semantic content included in the character string with semantic content from the user information list; and a step of creating animation from the determined animation element.

By this means, intentions on the story creation side and intentions on the side on which a video is created using that story can be reconciled in a balanced manner, and the relationship between description content according to an original keyword and a character string with semantic content can be made one of reversibility.

A sixth aspect of the present invention employs a configuration whereby, in the video creating method according to the fifth aspect, there are included: a step of providing a list of keywords and a list of semantic content corresponding to those keywords; a step of inputting a character string; a step of extracting a keyword from the character string using the list of keywords; and a step of generating a character string with semantic content in which semantic content has been added to the extracted keyword using the list of semantic content.

By this means, information lacking in input information of some kind can be provided, and created animation video can be given expressiveness.

The present application is based on Japanese Patent Application No. 2005-274285 filed on Sep. 21, 2005, the entire content of which is expressly incorporated herein by reference.

### INDUSTRIAL APPLICABILITY

According to the present invention, video full of originality and reflecting the intent of a viewer can be created using an animation element based on user preference not provided in the system without modifying a story indicated by a character string with semantic content. The present invention also offers broad potential for use among users of animation mail exchange applications and chat applications, applications that implement presentations using characters and so forth, game programs using CG (computer graphics), and the like.

1. A video creating apparatus that creates animation using an animation element based on a story, comprising:
an input section that inputs a character string with semantic content including a keyword for describing a story and semantic content assigned to the keyword;
a user information list storage section that stores a user information list, which is a list in which a set of a keyword and semantic content for the keyword and an animation element used to create animation are associated on the side of a user playing back animation;
an animation constituent element determining section that determines an animation element corresponding to a set of a keyword included in the input character string with semantic content and semantic content assigned to the keyword from the user information list; and
an animation creating section that creates animation using the determined animation element.

2. The video creating apparatus according to claim 1, wherein the animation constituent element determining section, when there is no association of an animation element with a set of a keyword and semantic content assigned to the keyword included in the input character string with semantic content in the user information list, determines an animation element corresponding to input semantic content assigned to the keyword from the user information list.

3. The video creating apparatus according to claim 2, wherein the animation constituent element determining section, when there is no association of an animation element with semantic content assigned to a keyword in the user information list, determines an animation element corresponding to the semantic content from a previously established animation element information list, which is a list in which a set of a keyword and semantic content for the keyword and an animation element are associated.

4. The video creating apparatus according to claim 1, further comprising a user information adding section that adds an association between a set of a keyword and semantic content for the keyword and an animation element to the user information list.

5. A video creating method that creates animation using an animation element based on a story, comprising:
a step of inputting a character string with semantic content including a keyword for describing a story and semantic content assigned to the keyword;
a step of determining an animation element corresponding to a set of a keyword and semantic content assigned to the keyword included in the input character string with semantic content from a user information list, which is a list in which a set of a keyword and semantic content for the keyword and an animation element used to create animation are associated on the side of a user playing back animation; and
a step of creating animation using the determined animation element.

6. The video creating method according to claim 5, further comprising:
a step of extracting a keyword from the input character string using a list of keywords; and
a step of generating a character string with semantic content based on the character string using a list in which a keyword and semantic content are associated.
